(19) United States
(12) Patent Application Publication
(10) Pub. No.: US 2003/0005612 A1
(43) Pub. Date: Jan. 9, 2003

(54) Desktop decoration with movable advertisement signs

(75) Inventors: William H. K. Chu, Taipei (TW); Te-Chi Su, Taipei Hsien (TW)

Correspondence Address: DAVID E. DOUGHERTY, DENNISON, SCHULTZ & DOUGHERTY, 612 CRYSTAL SQUARE 4, 1745 JEFFERSON DAVIS HIGHWAY, ARLINGTON,, VA, 22202, US

(73) Assignee: Limax Electronics Co., Ltd.

(21) Appl. No.: 09/782,045

(22) Filed: Feb. 14, 2001

(51) Int. Cl. G09F 11/02

(52) U.S. Cl. 40/503

(57) ABSTRACT

Desktop decoration with movable advertisement signs, including a decoration main body, a reducing mechanism, a motor and a turning unit. The motor is coupled with the reducing mechanism for driving the turning unit. The turning unit includes multiple driven gears and driving gears which are interlaced with the driven gears and drivingly engaged with the driven gears. Each driving gear has an engaging member. A shaft bolt is passed through the engaging member and the driving gear to fixedly connect therewith. The engaging member is operatively leant on an intermittent wheel. An advertising column is fixed on upper side of each intermittent wheel and pivotally disposed in an outer frame, whereby when the respective advertising columns are turned, the picture is changed.

### BACKGROUND OF THE INVENTION

The present invention is related to a desktop decoration with movable advertisement signs. The desktop decoration includes a turning unit having multiple driven gears and driving gears which are interlaced with the driven gears and drivingly engaged with the driven gears. Each driving gear has an engaging member which is operatively leant on an intermittent wheel. An advertising column is fixed on upper side of each intermittent wheel. When the intermittent wheels are rotated, the advertising columns are synchronously rotated to change the picture into another one.

A conventional outdoor advertisement sign includes a frame body and multiple rotary seat units and resilient shafts mounted on the frame body and driven by a motor. An advertising column is disposed between each rotary seat unit and each resilient shaft. Each rotary seat unit includes a driven shaft, two bearing seats, an intermittent wheel, a gear set, a rotary shaft and a rotary seat. The driven shaft is disposed between the bearing seats. The intermittent wheel is fixedly mounted on the driven shaft for coupling with a transmission wheel of the driving shaft. The driving shaft is driven by the motor to transmit power via the transmission wheel, intermittent wheel, gear set and rotary shaft to the rotary seat for turning the advertising column and showing the advertising picture. Accordingly, different pictures can be converted and shown. However, such structure includes numerous components and it is time-consuming to assemble these components and the manufacturing cost is relatively high. Moreover, multiple intermittent wheels and gear sets are serially fitted on one driven shaft so that it is difficult to maintain the structure later.

### SUMMARY OF THE INVENTION

It is therefore a primary object of the present invention to provide a desktop decoration with movable advertisement signs. The engaging members, intermittent wheel and advertising columns are pivotally movably assembled with each other and then the respective gears are engaged with each other. When rotated, the advertising columns are synchronously rotated to change the picture into another one. The assembling procedure can be quickly performed and the maintenance is easy. Also, the manufacturing cost is lower.

It is a further object of the present invention to provide the above desktop decoration with movable advertisement signs in which the engaging arms of the engaging members fixed on the driving wheels are drivingly engaged with the U-shaped recesses of the intermittent wheel. When rotated, the advertising columns are synchronously rotated to change the picture into another one. This increases the fun and practical usability.

It is still a further object of the present invention to provide the above desktop decoration with movable advertisement signs in which the engaging arms of the engaging members can be preset with different angles. Accordingly, when rotated, the respective advertising columns can be rotated by preset difference in position so as to achieve a waved turning operation of the picture. This enhances the fun and practical usability.

According to the above objects, the desktop decoration with movable advertisement signs of the present invention includes a decoration main body, a reducing mechanism, a motor and a turning unit. The motor is coupled with the reducing mechanism for driving the turning unit. The turning unit is combined with the decoration main body, including multiple driven gears and driving gears which are interlaced with the driven gears and drivingly engaged with the driven gears. Each driving gear has an engaging member. A shaft bolt is passed through the engaging member and the driving gear to fixedly connect therewith.

The engaging member is operatively leant on an intermittent wheel. An advertising column is fixed on upper side of each intermittent wheel and pivotally disposed in an outer frame, whereby when the respective advertising columns are turned, the picture is changed.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 2a is an enlarged perspective exploded view of the advertising column and intermittent wheel of the present invention;

FIG. 3 is a sectional assembled view of the present invention;

FIG. 4 shows the engagement between the engaging member and intermittent wheel of the present invention;

FIG. 5 shows the operation of the present invention in one state;

FIG. 6 shows the operation of the present invention in another state; and

FIG. 7 is a perspective view showing the appearance of the present invention.

### DETAILED DESCRIPTION OF THE PREFERRED EMBODIMENT

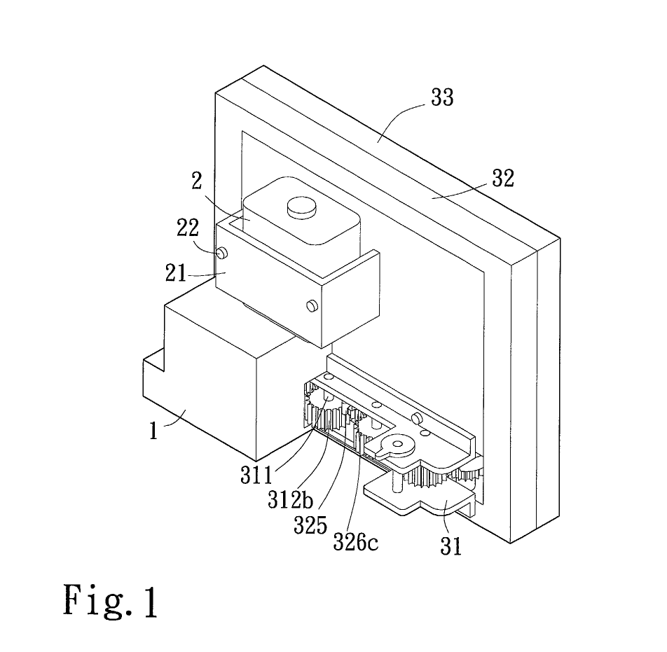

Please refer to FIGS. 1 to 3. The desktop decoration with movable advertisement signs of the present invention includes a reducing mechanism 1, a motor 2, a turning unit 3 and a decoration main body 4.

The turning unit 3 includes a symmetrical rack body 31 and multiple driven gears 312a˜312d movably mounted on the rack body 31 by multiple fixing shafts 311. The bending section of the rack body 31 is formed with two through holes 313. Bolts 314 are passed through the through holes 313 and screwed into corresponding thread holes 322 of an inner frame 32. The lower side of the inner frame 32 is formed with multiple pivot holes 328. A shaft bolt 323 is passed through an engaging member 324 and central through hole of driving gear 326a˜326e. The shaft bolt 323, engaging member 324 and driving gears 326a˜326e are fixedly adhered to each other. The engaging member 324 has an extending engaging arm 325 and a peripheral arch section 329. The shaft bolt 323 is passed through a collar 327 and movably fitted into the pivot hole 328. The driving gears 326a˜326e are interlaced with and drivingly engaged with the driven gears 312a˜312d

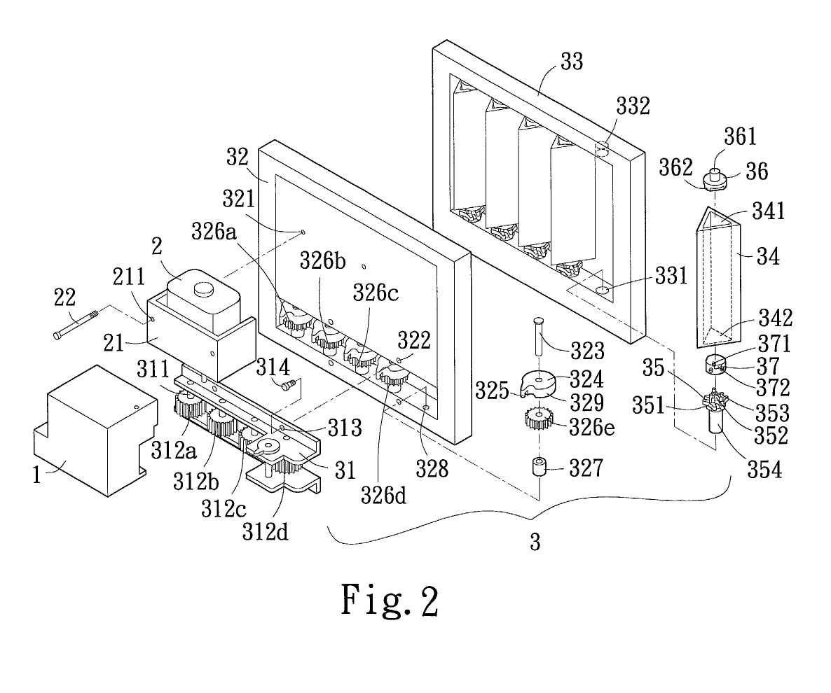

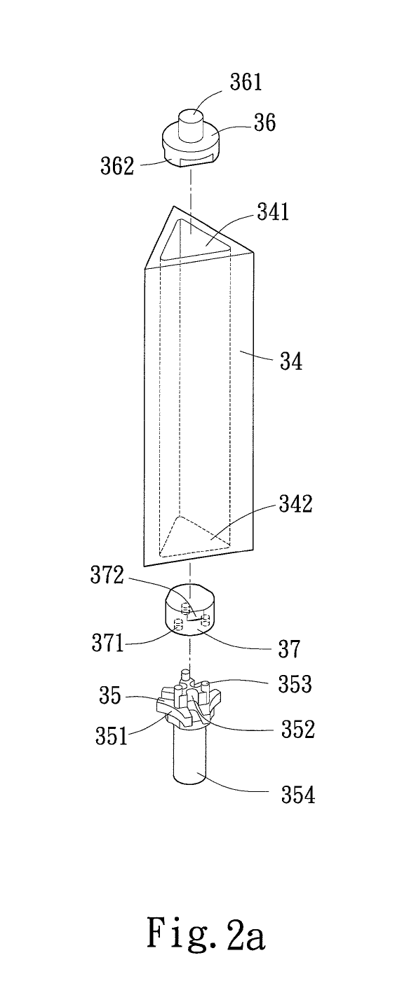

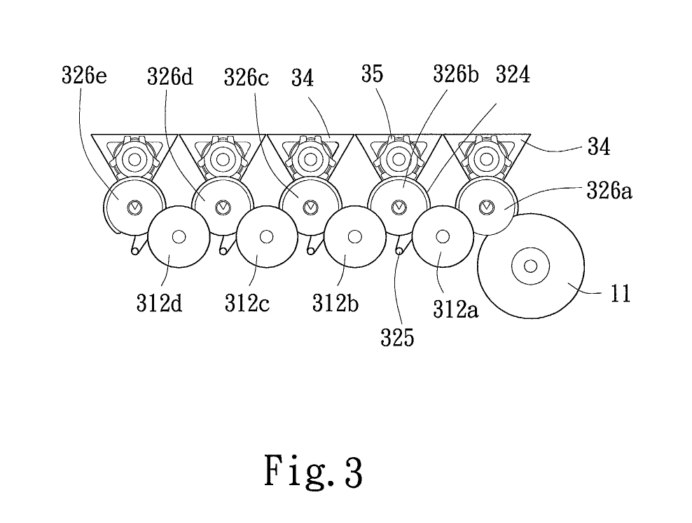

The driving gears 326a˜326e and the driven gears 312a˜312d are drivingly engaged with each other in the following manner (with reference to FIGS. 2 and 3): The motor 2 is coupled with the reducing mechanism 1 to rotate a driving gear 11. The driving gear 11 is engaged with the driving gear 326a on lower side of the inner frame 32. The driving gear 326a is engaged with a driven gear 312a which is further engaged with a driving gear 326b. Similarly, the driven gear 312d is engaged with the driving gear 326e. Accordingly, when the driving gear 11 is rotated, the driving gear 326a is rotated along with the driving gear 11. Also, the driven gear 312a is rotated along with the driving gear 326a and the driving gear 326b is rotated along with the driven gear 312a. Accordingly, the driving gears 326a˜326e and the driven gears 312a˜312d are interlaced and drivingly engaged with each other so that they will be synchronously rotated.

The inner frame 32 is lapped over an outer frame 33. The upper and lower sides of the outer frame 33 are respectively formed with multiple pivot holes 332, 331. Multiple advertising columns 34 are pivotally disposed at the pivot holes 332, 331. The top and bottom faces of each advertising column 34 are formed with sockets 341, 342. An oblique cut section 362 formed on bottom face of an upper cock block 36 is inlaid in the top socket 341. The upper side of the upper cock block 36 is provided with a rotary shaft 361 pivotally fitted in the pivot hole 332. An oblique cut section 372 formed on top face of a lower cock block 37 is inlaid in the bottom socket 342 of the advertising column 34. The lower side of the lower cock block 37 is provided with multiple fixing holes 371. Multiple projecting posts 353 formed on upper side of an intermittent wheel 35 are inserted in the fixing holes 371. The periphery of the intermittent wheel 35 are provided with multiple arch depressions 351 and U-shaped recesses 352 which are interlaced with each other. Each intermittent wheel 35 has a rotary shaft 354 on lower side, which is pivotally fitted in the pivot hole 331 of lower side of the outer frame 33. The engaging arms 325 of the engaging members 324 fixed on the driving wheels 326a˜326e are engaged with the U-shaped recesses 352 of the intermittent wheel 35 for rotating the intermittent wheel 35.

The motor 2 is mounted on a bracket 21. Bolts 22 are passed through through holes 211 of the bracket 21 to fix the bracket 21 at the thread holes 321 of the inner frame 32. The motor 2 is coupled with the reducing mechanism 1 for rotating the driving gear 11 meshing with the driving gear 326a.

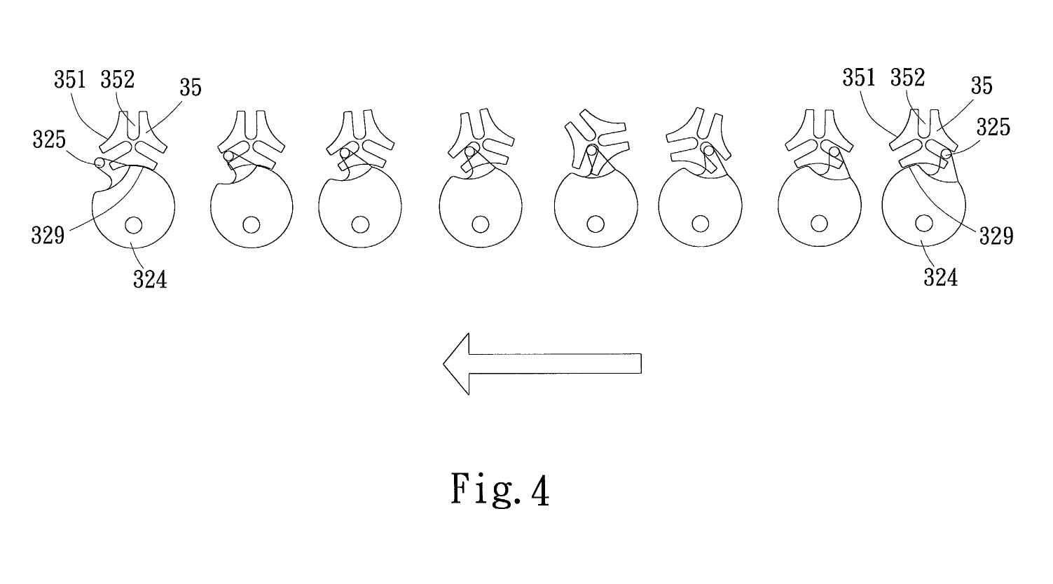

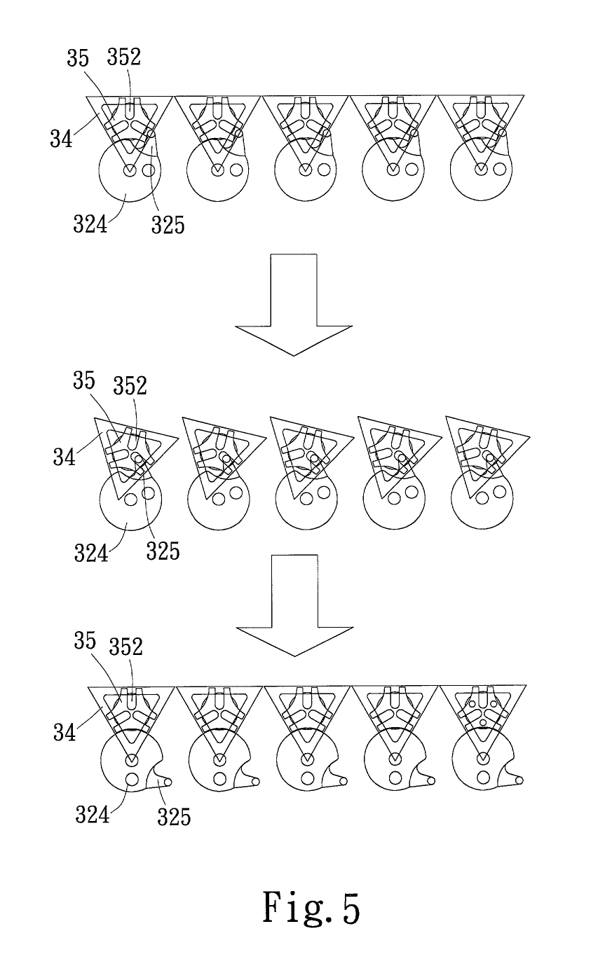

Referring to FIGS. 2 to 5, the driving gears 326a˜326e and the driven gears 312a˜312d are interlaced and drivingly engaged with each other. In addition, the engaging arms 325 of the engaging members 324 fixed on the driving wheels 326a˜326e are engaged with the U-shaped recesses 352 of the intermittent wheel 35 (with reference to FIGS. 4 and 5). When rotated, the engaging arm 325 gradually slides into the U-shaped recess 352. On the other hand, the contacting area between the arch section 329 of the engaging member 324 and the cooperative arch depression 351 of the intermittent wheel 35 is gradually reduced. Finally, the arch section 329 is separated from the arch depression 351 of the intermittent wheel 35. At this time, the advertising column 34 fixed on the intermittent wheel 35 is rotated. After the engaging arm 325 slides into the U-shaped recess 352, the engaging arm 325 will gradually slide out of the U-shaped recess 352 and separate therefrom. At this time, the arch section 329 of the engaging member 324 is restored to lean on the arch depression 351 of the intermittent wheel 35. Also, the advertising column 34 is synchronously rotated to change the picture into another one. The above procedure is repeated to continuously change the picture.

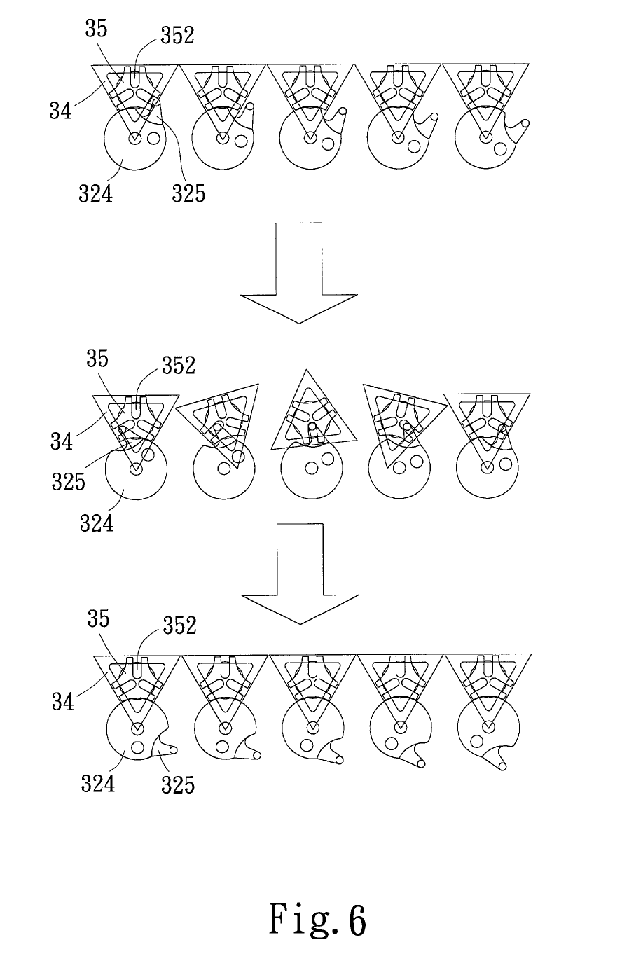

Referring to FIG. 6, in use, the engaging arm 325 of the engaging member 324 can be preset with different angles. Accordingly, when rotated, the respective advertising columns 34 can be rotated by preset difference in position so as to achieve a waved turning operation of the picture. This enhances the fun and practical usability.

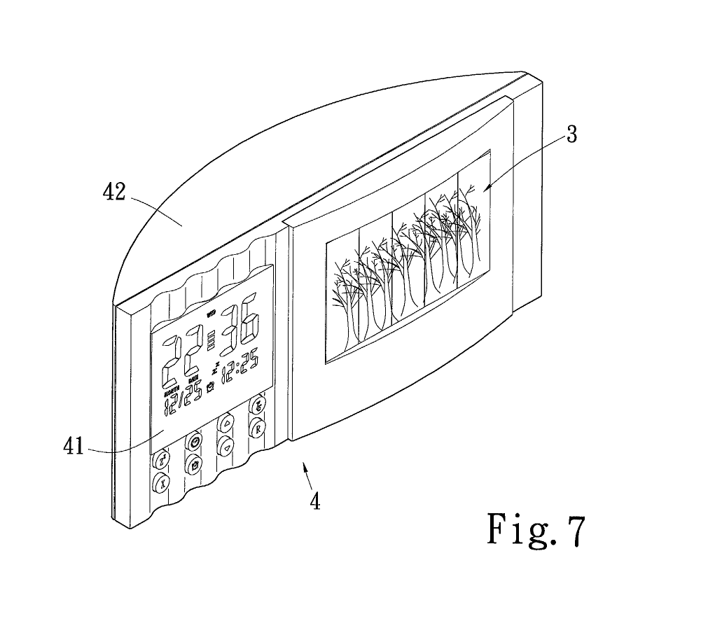

Referring to FIG. 7, the turning unit is combined with the decoration main body 4 which includes a clock 41 (or other decorations) and a housing 42.

According to the above arrangement, the present invention has the following advantages:

1. The engaging arms of the engaging members fixed on the driving wheels are drivingly engaged with the U-shaped recesses of the intermittent wheel. When rotated, the advertising columns are synchronously rotated to change the picture into another one. This increases the fun and practical usability.

2. The engaging arms of the engaging members can be preset with different angles. Accordingly, when rotated, the respective advertising columns can be rotated by preset difference in position so as to achieve a waved turning operation of the picture. This enhances the fun and practical usability.

3. The engaging members, intermittent wheel and advertising columns are pivotally movably assembled with each other and then the respective gears are engaged with each other. The assembling procedure can be quickly performed and the maintenance is easy. Also, the manufacturing cost is lower.

The above embodiment is only used to illustrate the present invention, not intended to limit the scope thereof. Many modifications of the above embodiment can be made without departing from the spirit of the present invention.

What is claimed is:

1. Desktop decoration with movable advertisement signs, comprising a decoration main body, a reducing mechanism, a motor and a turning unit, the motor being coupled with the reducing mechanism for driving and turning respective advertising columns of the turning unit, said desktop decoration being characterized in that the turning unit includes multiple driven gears and driving gears which are interlaced with the driven gears and drivingly engaged with the driven gears, each driving gear having an engaging member fixed thereon, a shaft bolt being passed through the engaging member and the driving gear to fixedly connect therewith, the engaging member being operatively leant on an intermittent wheel, an advertising column being fixed on upper side of each intermittent wheel and pivotally disposed in an outer frame, whereby when the respective advertising columns are turned, the picture is changed.

2. Desktop decoration with movable advertisement signs as claimed in claim 1, wherein the engaging member is operatively leant on the intermittent wheel in such a manner that the engaging member has an extending engaging arm and a peripheral arch section, whereby when rotated, the engaging arm of the engaging member is drivingly engaged in a U-shaped recess of the intermittent wheel and the arch section of the engaging member is leant on an arch depression of the intermittent wheel.

3. Desktop decoration with movable advertisement signs as claimed in claim 1, wherein the shaft bolt is passed through the engaging member and central through hole of the driving gear, the shaft bolt, engaging member and driving gears being fixedly adhered to each other, the shaft bolt being passed through a collar and movably fitted into a pivot hole of an inner frame for rotating the engaging member.

4. Desktop decoration with movable advertisement signs as claimed in claim 1, wherein a top and a bottom faces of each advertising column are formed with sockets, an oblique cut section formed on bottom face of an upper cock block being inlaid in the top socket, an upper side of the upper cock block being provided with a rotary shaft pivotally fitted in the pivot hole of the outer frame, an oblique cut section formed on top face of a lower cock block being inlaid in the bottom socket of the advertising column, the lower side of the lower cock block being provided with multiple fixing holes, multiple projecting posts formed on upper side of the intermittent wheel being inserted in the fixing holes, whereby when the intermittent wheel is rotated, the advertising columns are turned.

5. Desktop decoration with movable advertisement signs as claimed in claim 1, wherein the intermittent wheel has a rotary shaft on lower side, which is pivotally fitted in the pivot hole of lower side of the outer frame, whereby the intermittent wheel can be rotated.

6. Desktop decoration with movable advertisement signs as claimed in claim 1, wherein the decoration main body is a clock housed in a housing and combined with the turning unit.

7. Desktop decoration with movable advertisement signs as claimed in claim 2, wherein the intermittent wheel has a rotary shaft on lower side, which is pivotally fitted in the pivot hole of lower side of the outer frame, whereby the intermittent wheel can be rotated.

8. Desktop decoration with movable advertisement signs as claimed in claim 4, wherein the intermittent wheel has a rotary shaft on lower side, which is pivotally fitted in the pivot hole of lower side of the outer frame, whereby the intermittent wheel can be rotated.
